(19) United States
(12) Patent Application Publication
(10) Pub. No.: US 2011/0225403 A1
(43) Pub. Date: Sep. 15, 2011

(54) OPERATING SYSTEM AND METHOD OF RUNNING THEREOF

(76) Inventor: Krzysztof Uchronski, (US)

(21) Appl. No.: 12/759,955

(22) Filed: Apr. 14, 2010

(30) Foreign Application Priority Data
Mar. 11, 2010 (GB) 1004050.9

(51) Int. Cl. G06F 9/00; G06F 9/24

(52) U.S. Cl. 713/1

(57) ABSTRACT

A method of running an operating system comprises a two-step process. Firstly, in a set-up phase, there is carried out the loading of a driver when the operating system is booted, an operating system component transmitting a call to a kernel component for a function table, the driver intercepting the call from the operating system component to the kernel component, the driver replacing a specific callout in the function table with a replacement callout to the driver, the driver supplying the amended function table to the operating system component, the operating system component invoking the replacement callout to the driver, the driver invoking the original callout to the kernel component for a second function table, the driver replacing a specific function call in the second function table with a replacement function call to the driver, and the driver supplying the amended second function table to the operating system component. In the second phase, the operating system component invokes the replacement function call to the driver, the driver invoking the original function call to the kernel component for a result, the driver changing the received result to TRUE, and the driver supplying the replacement result to the operating system component.

### CROSS-REFERENCE TO RELATED APPLICATIONS

This application claims priority of co-pending Great Britain Patent Application No. 1004050.9 filed Mar. 11, 2010 and entitled IMPROVEMENTS RELATING TO OPERATING SYSTEMS, which is incorporated by reference herein in its entirety for all purposes.

### BACKGROUND OF THE INVENTION

This invention relates to a method of running an operating system.

Modern desktop computers all use an operating system. The operating system is an interface between the physical hardware of the computer and the user. The operating system is responsible for various tasks, including the management and coordination of activities and the sharing of the resources of the computer. The operating system also acts as a host for computing applications being run on the computer. As a host, one of the purposes of an operating system is to handle the resource allocation and access protection of the hardware. The Microsoft Windows line of operating systems has almost 90% of the desktop computer market.

Operating systems offer a number of services to application programs and users. Applications access these services through application programming interfaces (APIs) or system calls. By invoking these interfaces, an application can request a service from the operating system, supplying parameters, and receive the results of the operation. Users may also interact with the operating system, for example by using a software user interface through typing commands at a command line interface or by using a graphical user interface. For hand-held and desktop computers, the user interface is generally considered part of the operating system. On larger multi-user systems, the user interface is generally implemented as an application program that runs outside the operating system.

When a new operating system is developed, since it will be deployed on a wide variety of end computers with very different hardware capabilities, it is common for some features within the operating system to be optional or to have different alternatives designed to suit different computing hardware. One such operating system is Windows Vista. In Vista, a number of different display modes are supported, depending upon the capability of the graphics processing unit that is available on the computer that is running Vista. The preferred and most powerful display mode is called “Aero”. Aero is built on a new desktop composition engine called Desktop Window Manager. Aero provides support for numerous complex visual capabilities such as 3D graphics, translucency effects, live thumbnails, and window animations. Aero is intended for mainstream and high-end video cards. To enable the features listed above, Aero has significantly higher hardware requirements than its predecessors. The minimum requirement is for 128 MB of graphics memory, depending on resolution used. Vista also provides a basic display mode. This style does not employ the Desktop Window Manager, and does not feature transparency or translucency, window animation, Windows Flip 3D or any of the functions provided by the DWM. For computers with video cards that are not powerful enough to support Aero, the basic video mode is the default graphics mode.

However, third parties who provide hardware and/or software that will provide display functionality must ensure that their display solutions will work with all of the display modes that are provided within Windows Vista. In particular, it is not sufficient to provide a display solution that only works with Vista Aero, the solution must also work with Vista Basic Mode Video. An example of such a display solution is the provision of an additional monitor for a computer that can be connected to the computer via a USB socket rather than a conventional VGA socket. Such an additional monitor will consist of hardware connections and software controlling the additional monitor and these must work even if the computer is running Vista Basic Mode Video. Since the basic mode operates in certain restrictive ways with respect to the creation and transmission of display data within the operating system, it is essential that any third party display solutions are still able to fully function, even in light of these restrictions of the basic mode.

It is therefore an object of the invention to improve upon the known art.

### BRIEF SUMMARY OF THE INVENTION

According to a first aspect of the present invention, there is provided a method of running an operating system comprising: the operating system loading a driver when the operating system is booted, an operating system component transmitting a call to a kernel component for a function table, the driver intercepting the call from the operating system component to the kernel component, the driver replacing a specific callout in the function table with a replacement callout to the driver, the driver supplying the amended function table to the operating system component, the operating system component invoking the replacement callout to the driver, the driver invoking the original callout to the kernel component for a second function table, the driver replacing a specific function call in the second function table with a replacement function call to the driver, the driver supplying the amended second function table to the operating system component, the operating system component invoking the replacement function call to the driver, the driver invoking the original function call to the kernel component for a result, the driver changing the received result to TRUE, and the driver supplying the replacement result to the operating system component.

According to a second aspect of the present invention, there is provided an operating system comprising a driver, an operating system component and a kernel component wherein the driver is arranged to load when the operating system is booted, the operating system component is arranged to transmit a call to the kernel component for a function table, the driver is arranged to intercept the call from the operating system component to the kernel component, replace a specific callout in the function table with a replacement callout to the driver and supply the amended function table to the operating system component, the operating system component is arranged to invoke the replacement callout to the driver, the driver is arranged to invoke the original callout to the kernel component for a second function table, replace a specific function call in the second function table with a replacement function call to the driver and supply the amended second function table to the operating system component, the operating system component is arranged to invoke the replacement function call to the driver, and the driver is arranged to invoke the original function call to the kernel component for a result, change the received result to TRUE, and supply the replacement result to the operating system component.

Owing to the invention, it is possible to compel the formation of a shadow surface that will be created for the current primary surface, which will result in display data being present at the shadow surface, which can be accessed for use by the driver, in relation to a secondary display device. The operating system component will invoke the replacement function call that has been altered in the set-up phase. The invocation of this path will be using the replacement function call which will communicate with the driver instead of directly with the kernel component. The driver will then invoke the original function call and receive the result from the kernel component. This result will likely be “FALSE” and the result will be changed to “TRUE” if it is “FALSE” and will be left as “TRUE” if that is the returned result. This replacement result is then supplied to the operating system component. The entire set-up and activation process is transparent as far as the operating system component is concerned. This operating system component is not aware that the function tables have been changed during the set-up process. Similarly the actual activation process is carried out without the operating system component being aware that the result of the function call has been altered from the correct result returned by the kernel component.

The function call comprises a query as to whether a GDIPath should be used. Since this result is forced to return “TRUE”, then a GDIPath will be used and, following the driver supplying the replacement result to the operating system component, there is created a shadow surface. Any display data is then supplied to the shadow surface, and the driver can access the display data on the shadow surface and supply at least a portion of the accessed display data to an external display device.

### BRIEF DESCRIPTION OF THE DRAWINGS

Embodiments of the present invention will now be described, by way of example only, with reference to the accompanying drawings, in which:

FIG. 1 is a schematic diagram of computing system,

FIG. 2 is a schematic diagram of software components of the computing system, and

FIGS. 3 and 4 are schematic diagram showing communications between software components.

### DETAILED DESCRIPTION OF THE INVENTION

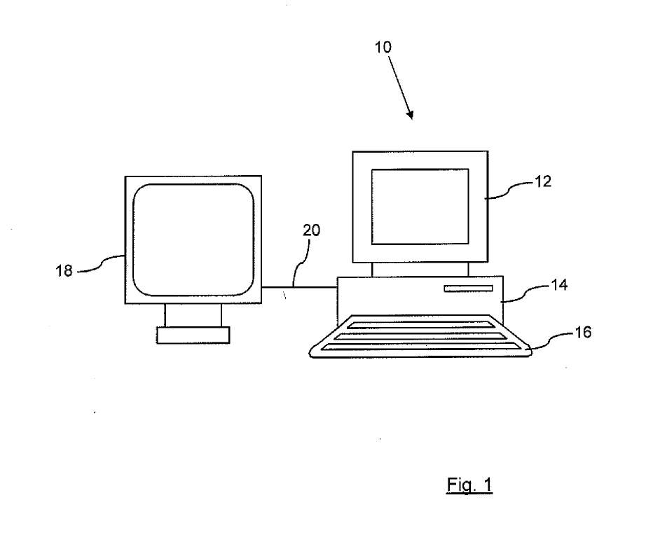

A computing system is illustrated in FIG. 1, which includes a desktop computer 10. The computer 10 comprises a display device 12, a processing device 14 and a user input device 16, being a keyboard. The display device 10 is connected to the processing device 14 via a VGA connection and the keyboard 16 is connected to the processing device 14 via a USB connection. An auxiliary display device 18 is also connected to the computer 10. This additional display device 18 is connected directly to the processing device 14 via a USB connection 20. Other peripheral devices may also be connected to the computer 10 such as additional input devices such as a mouse and additional output devices such as a printer.

The processing device 14 is responsible for the control of the output of the two display devices 12 and 18. A graphics processing unit within the processing device 14 will control the display device 12 over the VGA connection and a central processing unit within the processing device 14 will control the additional display device 18 over the USB connection 20. The additional display device 18 can be controlled to display the same image as is being shown by the principal display device 12, or can be controlled to display a different image. One or more display buffers (either hardware or software) are present within the processing device 14, which define the display data displayed by the respective display device 12 and 18.

The secondary display device 18 can be controlled to display an image that is essentially a continuation of the image being displayed by the main display device 12. In this case, a virtual desktop is created within the processing device 14 which allows the user to move their cursor between the images displayed by the two display devices 12 and 18. This creates a larger usable working display area for business professionals. Display data for the additional display device 18 is created by software being run by the processing device 14 and this software must process the display data so that it can be carried over the USB link 20, which in general does not have a sufficient data rate to be suitable for continuous video data.

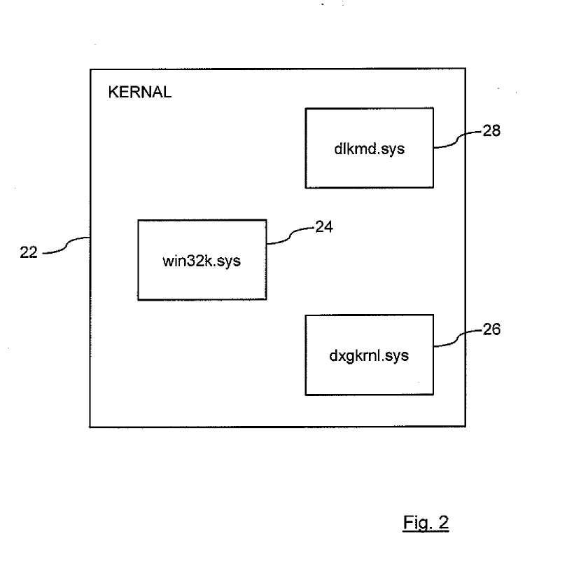

In order to control the additional display device 18, a dedicated software driver for the display device 18 needs to be present and accessible by the operating system of the computer 10. FIG. 2 provides a schematic representation of the operating system 22 of the computer 10 with an operating system component 24, a kernel component 26 and a dedicated driver 28. It will be appreciated that in a fully-functioning operating system a very large number of different components and drivers are in use at any one time once the operating system 22 has booted, initially loading a copy of the operating system into local memory and loading drivers and other components into the local memory.

The driver 28 has been supplied by the company that is providing the connection technology to add the secondary monitor 18. The driver 28 may be provided by a CD-ROM, downloaded from an external source via the Internet, or may be uploaded when the secondary display device 18 is first connected. The USB connection 20 may include a small piece of hardware which is involved in the construction of the display image that is used by the second display 18, and the driver 28 can be stored by that hardware and uploaded to the processing device 14, and hence the operating system 22, when the USB connection of the secondary display device 18 is first made.

As has been discussed above, with reference to the prior art, the driver 28 and the connection system of the USB connection 20 and additional display device 18 must work with all of the operating systems 22 that are in use in modern computing systems. Indeed, again as discussed above, modern operating systems, such as Windows Vista, have multiple display modes, and the functionality provided by the driver 28 and the display device 18 must work with these different display modes. When a user buys the connection technology embodied by the USB connection 20, they must find that the operating system configuration that they are using on their local computer 10 will be able to deliver the additional display functionality they are expecting.

When using an operating system such as Windows Vista, by default basic mode video playback, or indeed any DirectX application in basic mode, renders frames to video (GPU accessible) memory swap chain buffers and then presents the display data to the primary surface. The primary surface is the surface currently visible on the monitor 12. However a primary surface is not even available for USB-connected display devices and also any CPU read back from a primary surface is always slow, even when primary surfaces are made available. Therefore an alternative method for getting access to video playback content is to force the video playback to present via a GDI path which will end up in video data being sent into a shadow surface.

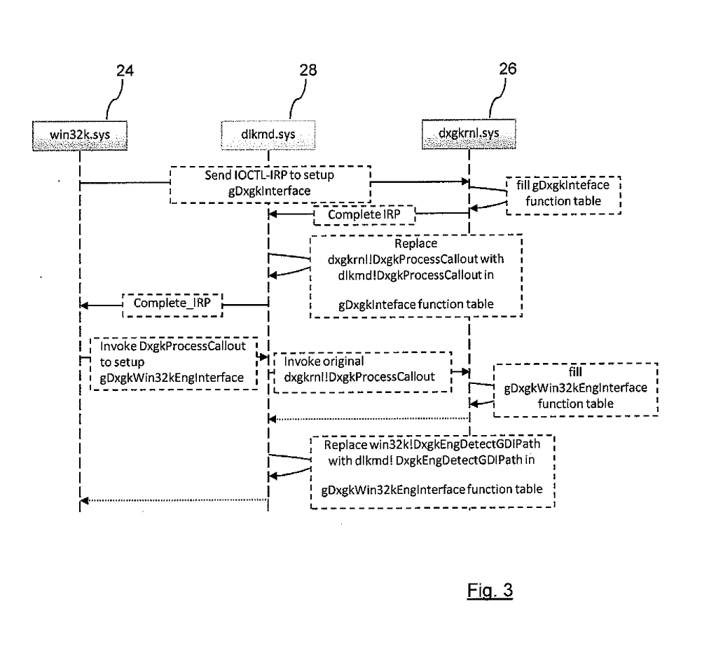

In order to force the operating system 22 to always use shadow surfaces, the driver 28 is operated to alter the result of the operating system win32k!DxgkEngDetectGDIPath routine. This function returns TRUE in situations when a GDI path needs to be used (for example when using sprites if a (GUI) context menu is being opened on top of the video playback area). The GDI path implies that operating system 22 should use lockable shadow surfaces which are CPU accessible and therefore the video frame buffer is directly readable by kernel mode drivers. To achieve this alteration of the result of the GDI path routine, the driver 28 needs to intercept various operating system communications, as illustrated in FIG. 3.

In order to change win32k!DxgkEngDetectGDIPath routine's result, the routine has to be hooked so that all calls made to this function are “visible” to the given kernel mode driver 28. To hook win32k!DxgkEngDetectGDIPath function two steps needs to be performed. Firstly, Win32K's IOCTL sent to DXGKRNL needs to be intercepted. This step is needed so that the original Dxgkrnl!DxgkProcessCallout routine can be replaced in win32k!gDxgkInterface function table with a non-OS one. This usually happens in the IOCTL IRP's completion routine in an arbitrary thread context. The second step is that the non-OS implementation of the DxgkProcessCallout original win32k!DxgkEngDetectGDIPath routine needs to be replaced in win32k!gDxgkWin32kEngInterface function table with a non-OS one.

The procedure described is using a non-standard and non-documented technique to enable video playback in basic video mode, which will work for both Windows Vista and Windows 7. win32k!DxgkEngDetectGDIPath is a non-exported and non-documented system function. The routine is typically called in the context of video player on behalf of the DXGKRNL driver 26 which takes its address from win32k!gDxgkWin32kEngInterface function table. The win32k!gDxgkWin32kEngInterface function table is being initialized in dxgkrnl!DxgkProcessCallout function (by DXGKRNL driver 26), which is called by Win32K subsystem. Win32K obtains address of dxgkrnl!DxgkProcessCallout routine from win32k!gDxgkInterface table. win32k!gDxgkInterface function table is usually initialized in the completion routine for the IRP that carries private IOCTL issued by Win32K component.

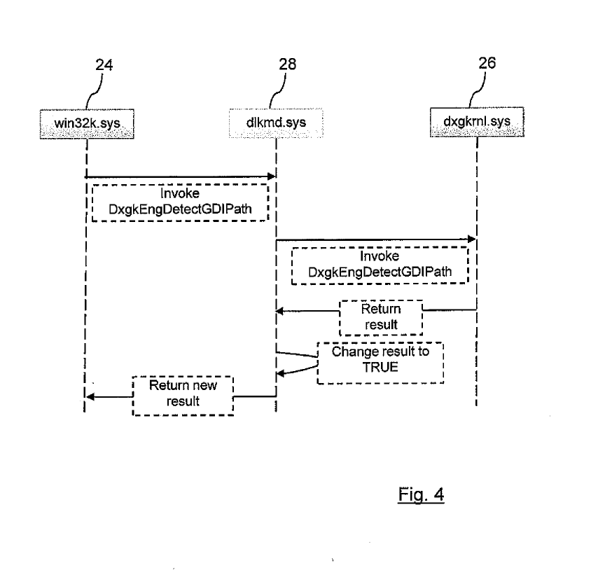

FIG. 4 shows the operating system component 24, which will invoke the dxgkEngDetectGDIPath that has been altered in the set-up phase described above with reference to FIG. 3. The invocation of this path will be using the replacement GDIPath which will communicate with the driver 28 instead of directly with the kernel driver 26. The driver 28 will then invoke the original GDIPath and receive the result from the dxgkrnl.sys component 26. This result will likely be “FALSE” and the result will be changed to “TRUE” if it is “FALSE” and will be left as “TRUE” if that is the returned result. This replacement result is then supplied to the operating system component 24.

The entire set-up and activation process is transparent as far as the win32k.sys operating system component 24 is concerned. This operating system component 24 is not aware that the function tables have been changed during the set-up process of FIG. 3. Similarly the actual activation process shown in FIG. 4 is carried out without the operating system component 24 being aware that the result of the GDIPath has been altered from the correct result returned by the kernel component 26. As a result of the “TRUE” result being sent back by the driver 28, a shadow surface will be created for the current primary surface, which will result in display data being present at the shadow surface, which can be accessed for use by the driver 28, in relation to the secondary display device.

What is claimed is:

1. A method of running an operating system comprising:
loading a driver when the operating system is booted;
transmitting a call from an operating system component to a kernel component for a function table;
intercepting the call from the operating system component to the kernel component;
replacing a specific callout in the function table with a replacement callout to the driver;
supplying the amended function table to the operating system component;
invoking the replacement callout to the driver;
invoking the original callout to the kernel component for a second function table;
replacing a specific function call in the second function table with a replacement function call to the driver;
supplying the amended second function table to the operating system component;
invoking the replacement function call to the driver;
invoking the original function call to the kernel component for a result;
changing the received result to TRUE; and
supplying the replacement result to the operating system component.

2. The method according to claim 1, wherein the function call comprises a query as to whether a GDIPath should be used.

3. The method according to claim 1 further comprising:
following supplying the replacement result to the operating system component, creating a shadow surface; and
supplying display data to the shadow surface.

4. The method according to claim 3 further comprising:
accessing the display data on the shadow surface and supplying at least a portion of the accessed display data to an external display device.

5. In a computer system having a processor and memory, an operating system comprising a driver, an operating system component and a kernel component, the operating system further comprising:
driver program logic arranged to load when the operating system is booted;
operating system component program logic arranged to transmit a call to the kernel component for a function table;
the driver program logic further arranged to:
(i) intercept the call from the operating system component program logic to the kernel component,
(ii) replace a specific callout in the function table with a replacement callout to the driver, and
(iii) supply the amended function table to the operating system component;
the operating system component program logic further arranged to invoke the replacement callout to the driver;
the driver program logic further arranged to:
(i) invoke the original callout to the kernel component for a second function table,
(ii) replace a specific function call in the second function table with a replacement function call to the driver, and
(iii) supply the amended second function table to the operating system component;
the operating system component program logic further arranged to invoke the replacement function call to the driver; and
the driver program logic further arranged to:
(i) invoke the original function call to the kernel component for a result,
(ii) change the received result to TRUE, and
(iii) supply the replacement result to the operating system component.

6. The system according to claim 5, wherein the function call comprises a query as to whether a GDIPath should be used.

7. The system according to claim 5, wherein the operating system is further arranged, following the driver supplying the replacement result to the operating system component, to create a shadow surface and supply display data to the shadow surface.

8. The system according to claim 7, wherein the driver is further arranged, to access the display data on the shadow surface and supply at least a portion of the accessed display data to an external display device.

9. A computer program product for use with a computer system executing operating system, the computer program product comprising a computer readable storage medium having program code embodied thereon, the program code comprising:
(A) program code for loading a driver when the operating system is booted;
(B) program code for transmitting a call from an operating system component to a kernel component for a function table;
(C) program code for intercepting the call from the operating system component to the kernel component;
(D) program code for replacing a specific callout in the function table with a replacement callout to the driver;
(E) program code for supplying the amended function table to the operating system component;
(F) program code for invoking the replacement callout to the driver;
(G) program code for invoking the original callout to the kernel component for a second function table;
(H) program code for replacing a specific function call in the second function table with a replacement function call to the driver;
(I) program code for supplying the amended second function table to the operating system component;
(J) program code for invoking the replacement function call to the driver;
(K) program code for invoking the original function call to the kernel component for a result;
(L) program code for changing the received result to TRUE; and
(M) program code for supplying the replacement result to the operating system component.

10. The computer program product according to claim 9 wherein the function call comprises a query as to whether a GDIPath should be used.

11. The computer program product according to claim 10 further comprising:
(N) program code for, following supplying the replacement result to the operating system component, creating a shadow surface; and
(O) program code for supplying display data to the shadow surface.
